(19) United States
(12) Patent Application Publication
(10) Pub. No.: US 2010/0126808 A1
(43) Pub. Date: May 27, 2010

(54) ELEVATOR APPARATUS

(75) Inventor: Naoki Hashiguchi, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Mitsubishi Electric Corporation, Chiyoda-ku, Tokyo (JP)

(21) Appl. No.: 11/814,327

(22) PCT Filed: Apr. 19, 2006
(86) PCT No.: PCT/JP2006/308200

§ 371 Date: Jul. 19, 2007

(51) Int. Cl. B66B 11/04; B66B 7/06; B66B 7/00

(52) U.S. Cl. 187/258

(57) ABSTRACT

An elevator device where drive means has a first drive device including a first drive sheave and a second drive device including a second drive sheave. The dimensions of the first and second drive devices measured in the direction of the rotation axes of the first and second drive sheaves are greater than the dimensions in the direction normal to the rotation axes, and the first and second drive devices are arranged such that the rotation axes are horizontal. Suspension means includes a first suspension belt passed over the first drive sheave and a second suspension belt passed over the second drive sheave.

### TECHNICAL FIELD

The present invention relates to an elevator apparatus having a structure in which drive means for raising/lowering a car and a counterweight is disposed in an upper portion of a hoistway.

### BACKGROUND ART

In a conventional elevator apparatus, a drive device is disposed above a counterweight. A belt is wound around a drive pulley of the drive device. A car and the counterweight, which are suspended within a hoistway by means the belt, are raised/lowered by the drive device (e.g., see Patent Document 1).

Patent Document 1: WO 2003/043925

### DISCLOSURE OF THE INVENTION

### Problem to be Solved by the Invention

In the conventional elevator apparatus constructed as described above, if the diameter of a motor of the drive device is increased to realize large capacity and high speed, the space between a corresponding wall of the hoistway and the car is enlarged. As a result, the hoistway needs to be increased in size.

The present invention has been made to solve the above-mentioned problem, and it is therefore an object of the present invention to provide an elevator apparatus capable of realizing large capacity and high speed with a compact installation space.

### Means for Solving the Problems

An elevator apparatus according to the present invention includes: a car and a counterweight that are raised/lowered within a hoistway; suspension means having a shape of a belt, for suspending the car and the counterweight within the hoistway; and drive means disposed in an upper portion of the hoistway, for raising/lowering the car and the counterweight via the suspension means, in which: the drive means has a first drive device including a first drive sheave, and a second drive device including a second drive sheave; each of the first drive device and the second drive device is larger in dimension in a direction along a corresponding one of rotary shafts of the first drive sheave and the second drive sheave than in a direction perpendicular to the corresponding one of the rotary shafts, and is disposed such that the corresponding one of the rotary shafts extends horizontally; and the suspension means includes a first suspension belt wound around the first drive sheave, and a second suspension belt wound around the second drive sheave.

Further, an elevator apparatus according to the present invention includes: a car and a counterweight that are raised/lowered within a hoistway; suspension means for suspending the car and the counterweight within the hoistway; and drive means disposed in an upper portion of the hoistway, for raising/lowering the car and the counterweight via the suspension means, in which: the drive means has a first drive device including a first drive sheave, and a second drive device including a second drive sheave; and each of the first drive device and the second drive device is larger in dimension in a direction along a corresponding one of rotary shafts of the first drive sheave and the second sheave than in a direction perpendicular to the corresponding one of the rotary shafts, and is disposed such that the corresponding one of the rotary shafts extends horizontally and so that each of the first drive device and the second drive device is located as a whole within a region between the car and a hoistway wall on a vertical projection plane.

Still further, an elevator apparatus according to the present invention includes: a car and a counterweight that are raised/lowered within a hoistway; suspension means for suspending the car and the counterweight within the hoistway; and drive means disposed in an upper portion of the hoistway, for raising/lowering the car and the counterweight via the suspension means, in which: the drive means has a first drive device including a first drive sheave, and a second drive device including a second drive sheave; and each of the first drive device and the second drive device is larger in dimension in a direction along a corresponding one of rotary shafts of the first drive sheave and the second drive sheave than in a direction perpendicular to the corresponding one of the rotary shafts, and is disposed such that the corresponding one of the rotary shafts extends horizontally and so that the first drive device and the second device are adjacent to each other in a direction that is horizontal and parallel to the rotary shafts.

Yet further, an elevator apparatus according to the present invention includes: a car and a counterweight that are raised/lowered within a hoistway; suspension means for suspending the car and the counterweight within the hoistway; and drive means disposed in an upper portion of the hoistway, for raising/lowering the car and the counterweight via the suspension means, in which: the drive means has a first drive device including a first drive sheave, and a second drive device including a second drive sheave; and each of the first drive device and the second drive device is larger in dimension in a direction along a corresponding one of rotary shafts of the first drive sheave and the second drive sheave than in a direction perpendicular to the corresponding one of the rotary shafts, and is disposed such that the corresponding one of the rotary shafts extends horizontally and so that the first drive device and the second drive device vertically overlap with each other.

Yet further, an elevator apparatus according to the present invention includes: a car and a counterweight that are raised/lowered within a hoistway; suspension means spending the car and the counterweight within the hoistway; and drive means disposed in an upper portion of the hoistway, for raising/lowering the car and the counterweight via the suspension means, in which: the car has a first car suspending portion and a second car suspending portion provided on an upper portion thereof; the counterweight has a first counterweight suspending portion and a second counterweight suspending portion provided thereon; the drive means has a first drive device including a first drive sheave, and a second drive device including a second drive sheave; each of the first drive device and the second drive device is larger in dimension in a direction along a corresponding one of rotary shafts of the first drive sheave and the second drive sheave than in a direction perpendicular to the corresponding one of the rotary shafts, and is disposed such that the corresponding one of the rotary shafts extends horizontally and so that each of the first drive device and the second drive device is located within a region of the car on a vertical projection plane; the suspension means includes a first suspension body wound around the first drive sheave and connected to the first car suspending portion and the first counterweight suspending portion, and a second suspension body wound around the second drive sheave and connected to the second car suspending portion and the second counterweight suspending portion; and the counterweight has provided thereabove a deflector pulley device for leading the first suspension body and the second suspension body to the first counterweight suspending portion and the second counterweight suspending portion, respectively.

### BRIEF DESCRIPTION OF THE DRAWINGS

FIG. 1 is a schematic plan view showing an elevator apparatus according to Embodiment 1 of the present invention.

FIG. 2 is a front view showing an essential part of elevator apparatus of FIG. 1.

FIG. 3 is a schematic plan view showing an elevator apparatus according to Embodiment 2 of the present invention.

FIG. 4 is a schematic plan view showing an elevator apparatus according to Embodiment 3 of the present invention.

FIG. 5 is a lateral view showing a structure for supporting a first drive device and a second drive device of FIG. 4.

FIG. 6 is a schematic plan view showing an elevator apparatus according to Embodiment 4 of the present invention.

FIG. 7 is a front view showing an essential part of the elevator apparatus of FIG. 6.

FIG. 8 is a schematic plan view showing an elevator apparatus according to Embodiment 5 of the present invention.

FIG. 9 is a front view showing an essential part of the elevator apparatus or FIG. 8.

FIG. 10 us a schematic plan view showing an elevator apparatus according to Embodiment 6 of the present invention.

FIG. 11 is a schematic plan view showing an elevator apparatus according to Embodiment 7 of the present invention.

FIG. 12 is a schematic view showing an elevator apparatus according to Embodiment 8 of the present invention.

FIG. 13 is a front view showing an essential part of the elevator apparatus of FIG. 12.

### BEST MODES FOR CARRYING OUT THE INVENTION

Preferred embodiments of the present invention will be described hereinafter With reference to the drawings.

### Embodiment 1

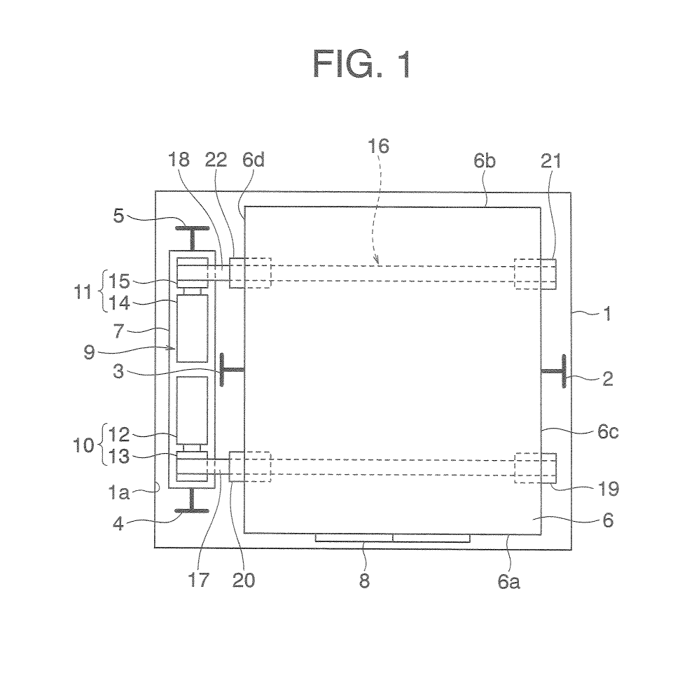

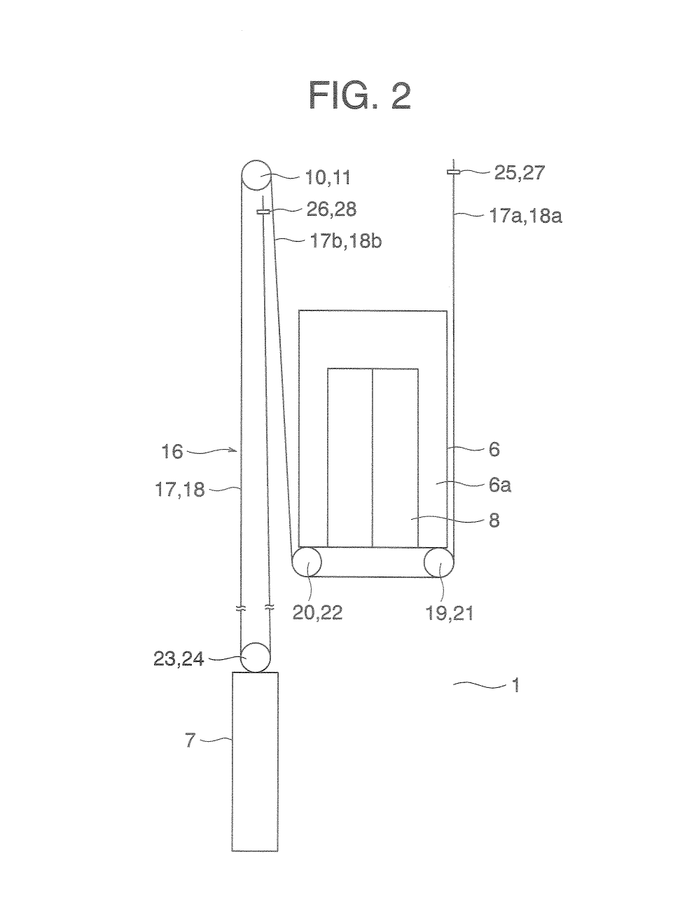

FIG. 1 is a schematic plan view showing an elevator apparatus according to Embodiment 1 of the present invention. FIG. 2 is a front view showing an essential part of the elevator apparatus of FIG. 1. Referring to FIG. 1, a first car guide rail 2, a second car guide rail 3, a first counterweight guide rail 4, and a second counterweight guide rail 5 are provided within a hoistway 1. Those guide rails 2 to 5 are not illustrated in FIG. 2. A car 6 is guided by the car guide rails 2 and 3 to be raised/lowered within the hoistway 1. A counterweight 7 is guided by the counterweight guide rails 4 and 5 to be raised/lowered within the hoistway 1.

The car 6 has a front surface portion 6a, a back surface portion 6b facing the front surface portion 6a, and a first lateral surface portion 6c and a second lateral surface portion 6d that face each other. The front surface portion 6a is provided with a pair of car doors 8 for opening/closing a car doorway. The first car guide rail 2 faces the first lateral surface on 6c. The second car guide rail 3 faces the second lateral surface portion 6d. The first car guide rail 2 and the second car guide rail 3 face each other at the same position in a longitudinal direction of the car 6. The car 6 is provided with a plurality of car guide shoes (not shown) for engaging the car guide rails 2 and 3, respectively.

The counterweight 7 is disposed beside the car 6 so as to face the second lateral surface portion 6d of the car 6 when being located at the same height as the car 6. The counterweight guide rails 4 and 5 face both ends of the counterweight 7 in a width direction thereof (longitudinal direction of car 6), respectively. The counterweight 7 is provided with a plurality of counterweight guide shoes (not shown) for engaging the counterweight guide rails 4 and 5, respectively.

Drive means for raising/lowering the car 6 and the counterweight 7 is disposed in an upper portion within the hoistway 1. The drive means 9 has a first drive device 10 and a second drive device 11, which are driven in synchronization with each other by an elevator control device (not shown). The first drive device 10 has a first drive device body 12 including a motor and a brake, and a first drive sheave 13 that is rotated by the first drive device body 12. The second drive 11 has a second drive device body 14 including a motor and a brake, and a second drive sheave 15 that is rotated by the second drive device body 14.

The same hoisting machine is employed as each of the first drive device 10 and the second drive device 11. This hoisting machine is larger in dimension in a direction along each of rotary shafts of the first drive sheave 13 and the second drive sheave 15 than in a direction perpendicular thereto. In addition, the drive sheaves 13 and 15 are directly driven by the motors of the drive device bodies 12 and 14, respectively, without the intervention of speed reducers.

The first drive device 10 and the second drive device 11 are disposed such that the rotary shafts of the drive sheaves 13 and 15 extend horizontally, and so as to be located as a whole in a region between the car 6 and a hoistway wall 1a facing the second lateral surface portion 6d on a vertical projection plane. The first drive device 10 and the second drive device 11 are disposed above the counterweight 7 so as to be superposed thereon on the vertical projection plane.

Further, the first drive device 10 and the second drive device 11 are disposed coaxially such that the rotary shafts of the drive sheaves 13 and 15 extend parallel to the width direction of the counterweight 7, and are disposed adjacent to each other in a direction that is horizontal and parallel to the rotary shafts of the drive sheaves 13 and 15.

Still further, the first drive sheave 13 and the second drive sheave 15 are disposed at first axial ends of the first drive device 10 and the second drive device 11, respectively. The first drive device 10 and the second drive device 11 are disposed such that second axial ends thereof face each other. That is, the first drive device 10 and the second drive device 11 are disposed reversely in orientation to each other.

The first drive device 10 and the second drive device 11 are supported by a support frame (not shown) fixed in the upper portion within the hoistway 1. The support frame is fixed to, for example, upper portions of the counterweight guide rails 4 and 5 to be supported thereby. Alternatively, the support frame may be supported by a support beam provided in an architectural structure.

The car 6 and the counterweight 7 are suspended within the hoistway 1 by suspension means 16. The suspension means 16 has a first suspension belt 17 as a first suspension body wound around the first drive sheave 13, and a second suspension belt 18 as a second suspension body wound around the second drive sheave 15. Each of the first suspension belt 17 and the second suspension belt 18 has a flat cross-section with a width dimension larger than a thickness dimension.

A plurality of (pair of) first car suspending pulleys 19 and 20 around which the first suspension belt 17 is wound, and a plurality of (pair of) second car suspending pulleys 21 and 22 around which the second suspension belt 18 is wound are provided on a lower portion of the car 6. The first suspending pulleys 19 and 20 are disposed in front of the car guide rails 2 and 3, respectively. The second car suspending pulleys 21 and 22 are disposed behind the car guide rails 2 and 3, respectively.

A first counterweight suspending pulley 23 around which the first suspension belt 17 is wound, and a second counterweight suspending pulley 24 around which the second suspension belt 18 is wound are provided on an upper portion of the counterweight 7. The suspending pulleys 19 to 24 are disposed such that rotary shafts thereof extend horizontally and parallel to the longitudinal direction of the car 6.

The first suspension belt 17 has a first car-side end 17a and a first counterweight-side end 17b. The first car-side end 17a is connected to a first car-side cleat 25 provided in the upper portion within the hoistway 1. The first counterweight-side end 17b is connected to a first counterweight-side cleat portion 26 provided in the upper portion within the hoistway 1. The first suspension belt 17 is wound around the first car suspending pulleys 19 and 20, the first drive sheave 13, and the first counterweight suspending pulley 23 in the stated order from the first car-side end 17a side.

The second suspension belt 18 has a second car-side end 18a and a second counterweight-side end 18b. The second car-side end 18a is connected to a second car-side cleat portion 27 provided in the upper portion within the hoistway 1. The second counterweight-side end 18b is connected to a second counterweight-side cleat portion 28 provided in the upper portion within the hoistway 1. The second suspension belt 18 is wound around the second car suspending pulleys 21 and 22, the second drive sheave 15, and the second counterweight suspending pulley 24 in the stated order from the second car-side end 18a side.

The first car-side cleat portion 25 and the second car-side cleat portion 27 are supported by, for example, the first car guide rail 2. The first counterweight-side cleat portion 26 and the second counterweight-side cleat portion 28 are supported by, for example, the support frame for supporting the drive devices 10 and 11. As described above, the car the counterweight 7 are suspended by the suspension belts 17 and 18 according to a 2:1 roping arrangement.

The components on the first suspension belt 17 side (first drive device 10, suspending pulleys 19, 20, and 23, first suspension belt 17, cleat portions 25 and 26, and the like) and the components the second suspension belt 18 side (second drive device 11, suspending pulleys 21, 22, and 24, second suspension belt 18, cleat portions 27 and 28, and the like) are disposed axisymmetrically around a centerline of the counterweight 7 in the width direction thereof on the vertical projection plane.

In the elevator apparatus constructed as described above, the car 6 and the counterweight 7 are raised/lowered using the two drive devices 10 and 11 and the suspension belts 17 and 18 belonging to two independent systems, respectively. It is therefore possible to increase the output of the entire drive means 9 without increasing the diameters of the motors, and hence realize large capacity and high speed with a compact installation space. It is also possible to reduce the diameters of the motors required for the achievement of the same performance as in the conventional art, and hence realize space saving.

Further, if only one of the drive devices 10 and 11 is employed in an elevator apparatus with small capacity and low speed and both the drive devices 10 and 11 are employed in an elevator apparatus with large capacity and high speed, it is possible to employ the same hoisting machine for the two types of the elevator apparatuses and hence reduce the cost for designing and manufacturing the hoisting machine. Still further, as will be illustrated in the following embodiments of the present invention as well, it is possible to enhance the degree of freedom in layout.

The first drive device 10 and the second drive device 11 are accommodated as a whole within the region between the second lateral surface portion 6d of the car 6 and the hoistway wall 1a on the vertical projection plane. It is therefore possible to dispose the drive devices 10 and 11 making effective use of the space above the counterweight 7, and hence make the hoistway 1 compact.

Further, the first drive device 10 and the second drive device 11 are disposed parallel to each other and reversely in orientation to each other, so the positions of the suspension belts 17 and 18 are not biased toward one side of the car 6. It is therefore possible to suspend the car 6 in a well-balanced manner.

### Embodiment 2

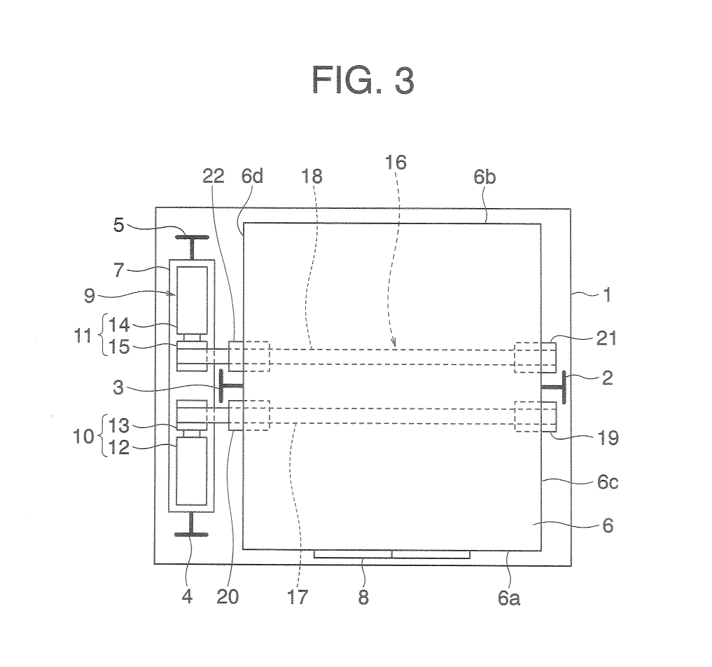

Reference will be made next to FIG. 3. FIG. 3 is a schematic plan view showing an elevator apparatus according to Embodiment 2 of the present invention. Referring to FIG. 3, the first drive device 10 and the second drive device 11 are disposed such that the first axial cods thereof (ends on drive sheaves 13 and 15 sides) face each other. Thus, the distance between the suspension belts 17 and 18, the respective distances between the first car suspending pulleys 19 and 20 and the second car suspending pulleys 21 and 22, and the distance between the first counterweight suspending pulley 23 and the second counterweight suspending pulley 24 are smaller than those of Embodiment 1 of the present invention, respectively. Embodiment 2 of the present invention is identical to Embodiment 1 of the present invention in other constructional details. The construction described above also makes it possible to achieve an effect similar to that of Embodiment 1 the present invention.

### Embodiment 3

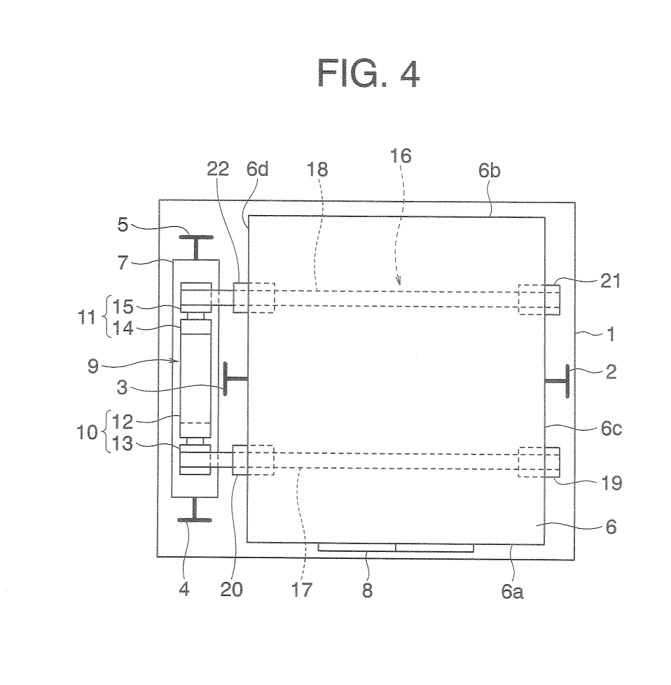

Reference will be made next to FIG. 4. FIG. 4 is a schematic plan view showing an elevator apparatus according to Embodiment 3 of the present invention. Referring to FIG. 4, the first drive device 10 and the second drive device 11 are disposed so as to vertically overlap with each other. In this example, the first drive device body 12 is disposed directly above the second drive device body 14.

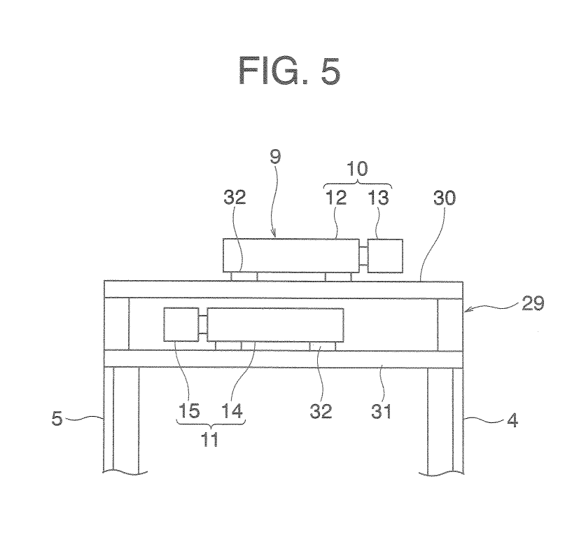

FIG. 5 is a lateral view showing a structure for supporting the first drive device 10 and the second drive device 11 of FIG. 4. A support frame 29 is fixed to the upper portions of the counterweight guide rails 4 and 5. The support frame 29 has an upper support portion 30 for supporting the first drive device 10, and a lower support portion 31 located below the upper support portion 30 to support the second drive device 11. The first drive device 10 and the second drive device 11 are supported by the support frame 29 via a plurality of vibration-proof members (rubber cushions) 32. The support frame 29 is not illustrated in FIG. 4. Embodiment 3 of the present invention is identical to Embodiment 1 of the present invention in other constructional details.

In the elevator apparatus constructed as described above, the first drive device 10 and the second drive device 11 are disposed so as to vertically overlap with each other. Therefore, even if axial dimensions of the first drive device 10 and the second drive device 11 are increased, both the drive devices 10 and 11 do not interfere with each other, and the axial dimension of the space for installing the drive means 9 is not increased. As a result, it is possible to realize large capacity and high speed with a compact installation space.

The first drive device 10 and the second drive device 11 may be disposed reversely in orientation to those of Embodiment 3 of the present invention as long as the suspension belts 17 and 18 do not interfere with the drive device bodies 12 and 14, respectively. For example, is possible prevent the suspension beats 17 and 18 from interfering with the drive device bodies 12 and 14, respectively, by making the diameters of the drive sheaves 13 and 15 larger than the diameters of the drive device bodies 12 and 14, respectively.

### Embodiment 4

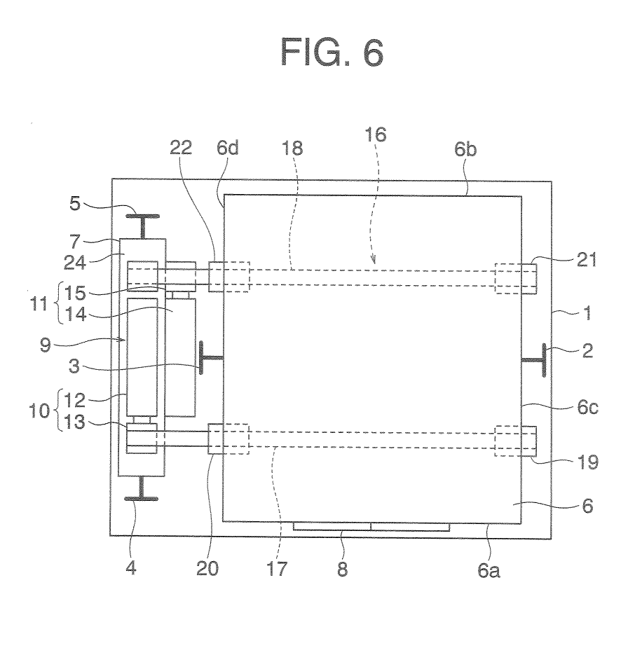

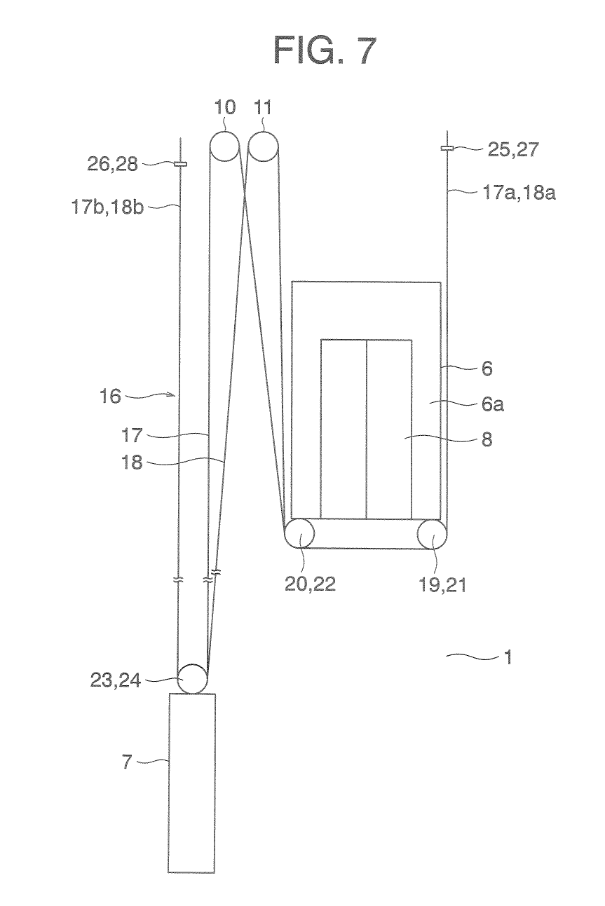

Reference will be made next to FIGS. 6 and 7. FIG. 6 is a schematic plan view showing an elevator apparatus according to Embodiment 4 of the present invention. FIG. 7 is a front view showing an essential part of the elevator apparatus of FIG. 6. Referring to FIGS. 6 and 7, the first drive device 10 and the second drive device 11 are disposed adjacent to each other in a direction that is horizontal and perpendicular to the rotary shafts of the drive sheaves 13 and 15. That is, the first drive device 10 and the second drive device 11 are disposed parallel to each other and side by side at the same height within the hoistway 1. Embodiment 4 of the present invention is identical to Embodiment 1 of the present invention in other constructional details.

In the elevator apparatus constructed as described above, the first drive device 10 and the second drive device 11 are disposed side by side at the same height. Therefore, even if the axial dimensions of the first drive device 10 and the second drive device 11 are increased, both the drive devices 10 and 11 do not interfere with each other, and the height dimension of the space for installing the drive means 9 is not increased. As a result, it is possible to realize large capacity and high speed with a compact installation space.

The first drive device 10 and the second drive device 11 may be disposed reversely in orientation to those of Embodiment 4 of the present invention. In Embodiment 4 of the present invention, the first drive device 10 and the second drive device 11 are disposed reversely in orientation to each other. However, the first drive device 10 and the second drive device 11 may be disposed identically in orientation with the axial positions thereof slightly offset from each other.

### Embodiment 5

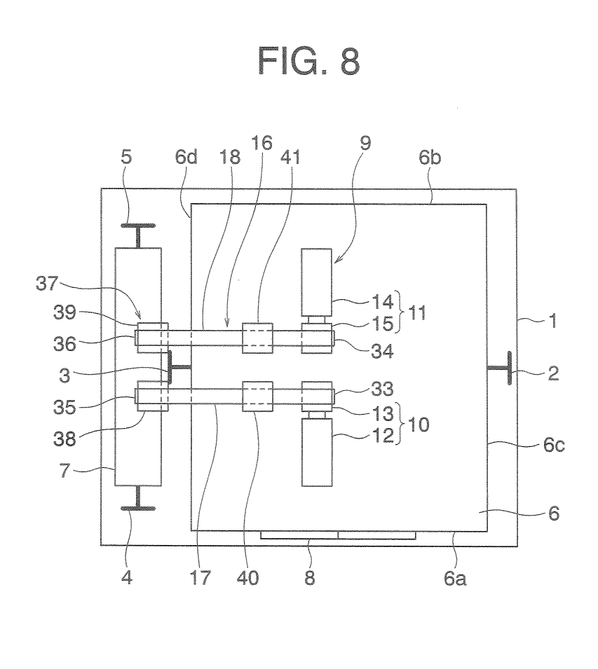

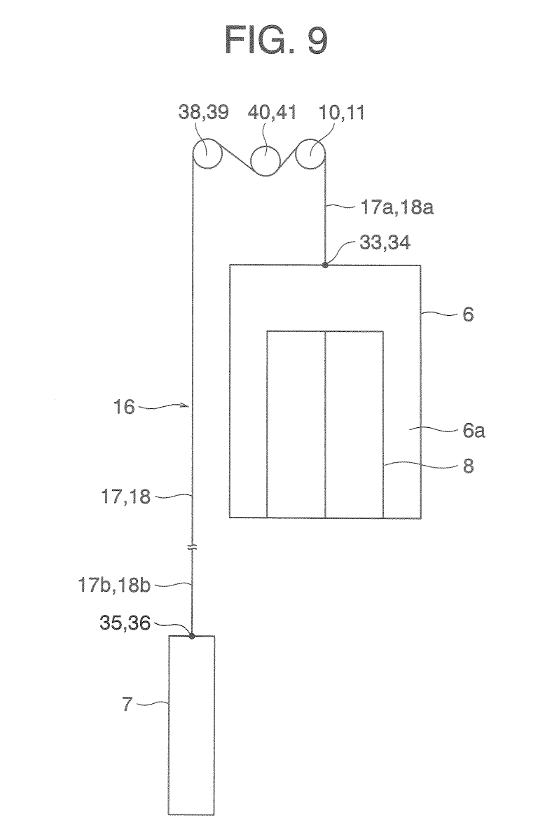

Reference will be made next to FIGS. 8 and 9. FIG. 8 is a schematic plan view showing an elevator apparatus according to Embodiment 5 of the present invention. FIG. 9 is a front view showing an essential part of the elevator apparatus of FIG. 8. In this example, the first drive device 10 and the second drive device 11 are disposed directly above the car 6 so as to be located within the region of the car 6 on the vertical projection plane. The first drive device 10 and second drive device 11 are disposed such that the rotary shafts of the drive sheaves 13 and 15 extend horizontally and parallel to the longitudinal direction of the car 6. In addition, the first drive device 10 and the second drive device 11 are disposed such that the first axial ends thereof face each other.

The car 6 and the counterweight 7 are suspended within the hoistway 1 the first suspension belt 17 and the second suspension belt 18 according to a 1:1 roping arrangement. For this purpose, a first car suspending portion 33 and a second car suspending portion 34 are provided on the upper portion of the car 6, and a first counterweight suspending portion 35 and a second counterweight suspending portion 36 are provided on the upper portion of the counterweight 7. The first car-side end 17a, the first counterweight-side end 17b, the second car-side end 18a, and the second counterweight-side end 18b are connected to the first car suspending portion 33, the first counterweight suspending portion 35, the second car suspending portion 34, and the second counterweight suspending portion 36, respectively. The car suspending portions 33 and 34 are disposed such that the centers thereof are located close to the center of gravity of the car 6 the vertical projection plane.

A deflector pulley device 37 for leading the first suspension belt 17 and the second suspension 18 to the first counterweight suspending portion 35 and the second counterweight suspending portion 36, respectively, is provided above the counterweight 7. The deflector pulley device 37 has a first deflector pulley 38 for leading first suspension belt 17 to the first counterweight suspending portion 35, and a second deflector pulley 39 for leading the second suspension belt 18 to the second counterweight suspending portion 36.

A first looping angle adjusting pulley 40 for increasing the looping angle of the suspension belt 17 around the drive sheave 13 and a second looping angle adjusting pulley 41 for increasing the looping angle of the suspension belt 18 around the drive sheave 15 are provided between the drive sheaves 13 and 15 and the deflector pulleys 38 and 39, respectively.

The first drive device 10, the second drive device 11, the deflector pulleys 38 and 39, and the looping angle adjusting pulleys 40 and 41 are supported by the support frame (not shown) fixed in the upper portion within the hoistway 1. The support frame is fixed to, for example, the upper portion of at least one of the car guide rails 2 and 3 and the counterweight guide rails 4 and 5. Alternatively, the support frame may be supported by the support beam provided in the architectural structure.

The drive sheaves 13 and 15, the deflector pulleys 38 and 39, and the looping angle adjusting pulleys 40 and 41 are disposed such that the rotary shafts thereof extend horizontally and parallel to the longitudinal direction of the car 6. The components on the first suspension belt 17 side (first drive device 10, deflector pulley 38, first suspension belt 17, looping angle adjusting pulley 40, and the like) and the components on the second suspension belt 18 side (second drive device 11, deflector pulley 39, second suspension belt 18, looping angle adjusting pulley 41, and like) are disposed axisymmetrically around the centerline of the counterweight 7 in the width direction thereof on the vertical projection plane. Embodiment 5 of the present invention is identical to Embodiment 1 of the present invention in other constructional details.

In the elevator apparatus constructed as described above, the car 6 and the counterweight 7 are raised/lowered using the two drive devices 10 and 11 and the suspension belts 17 and 18 belonging to two independent systems, respectively. It is therefore possible to increase the output the entire drive means 9 without increasing the diameters of the motors, and hence realize large capacity and high speed with a compact installation space. It is also possible to reduce the diameters of the motors required for the achievement of the same performance as in the conventional art, and hence realize space saving.

The looping angle adjusting pulleys 40 and 41 are also employed. It is therefore possible to increase the respective looping angles of the suspension belts 17 and 18 around the drive sheaves 13 and 15 and hence ensure a sufficient traction force.

### Embodiment 6

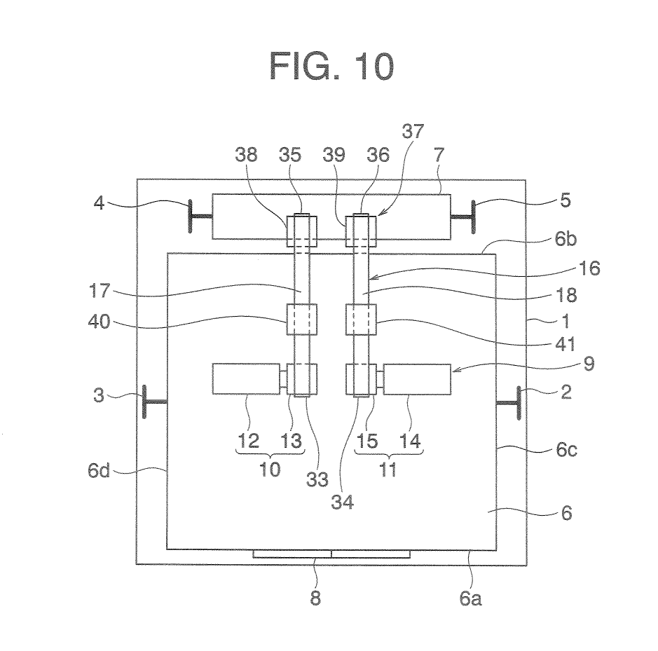

Reference will be made next to FIG. 10. FIG. 10 is a schematic plan view showing an elevator apparatus according to Embodiment 6 of the present invention. Referring to FIG. 10, the counterweight 7 is disposed behind the car 6 so as to face the back surface portion 6b of the car 6 when being located at the same height as the car 6. Thus, the drive sheaves 13 and 15, the deflector pulleys 38 and 39, and the looping angle adjusting pulleys 40 and 41 are disposed such that the rotary shafts thereof extend horizontally and parallel to the width direction of the car 6. Embodiment 6 of the present invention is identical to Embodiment 5 of the present invention in other constructional details.

The construction as described above in which counterweight 7 is disposed behind the car 6 also makes it possible to achieve an effect similar to that of Embodiment 5 of the present invention.

In Embodiments 5 and 6 of the present invention, the drive devices 10 and 11 may be disposed reversely in orientation. The looping angle adjusting pulleys 40 and 41 may be dispensed with as long as a sufficient traction force can be ensured.

### Embodiment 7

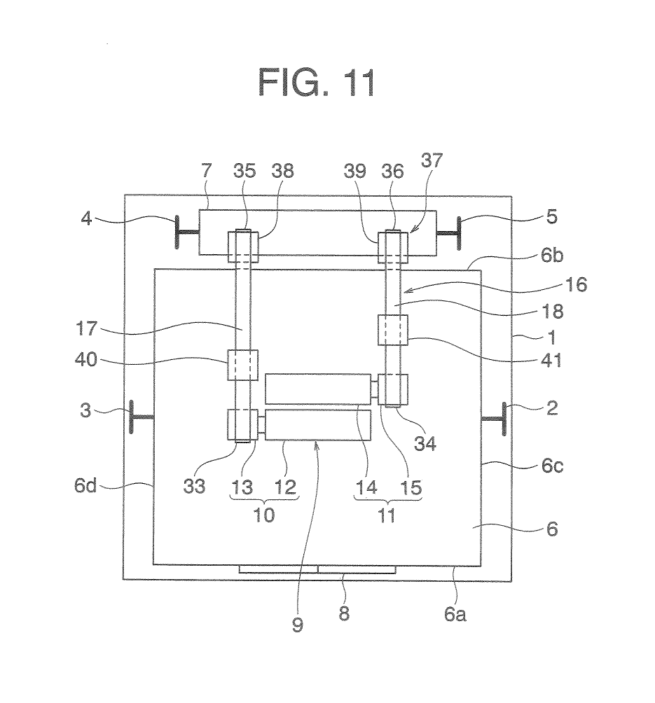

Reference will be made next to FIG. 11. FIG. 11 is a schematic plan view showing an elevator apparatus according to Embodiment 7 of the present invention. Referring to FIG. 11, the first drive device 10 and the second drive device 11 are disposed adjacent to each other in a direction that is horizontal and perpendicular to the rotary shafts of the drive sheaves 13 and 15. That is, the first drive device 10 and the second drive device 11 are disposed parallel to each other and side by side at the same height above the car 6. Embodiment 7 of the present invention is identical to Embodiment 6 of the present invention in other constructional details.

In the elevator apparatus constructed as described above, the first drive device 10 and the second drive device 11 are disposed side by side at the same height. Therefore, even if the axial dimensions of the first drive device 10 and the second drive device 11 are increased, both the drive devices 10 and 11 do not interfere with each other, and the height dimension of the space installing the drive means 9 is not increased. As result, it is possible to realize large capacity and high speed with a compact installation space.

### Embodiment 8

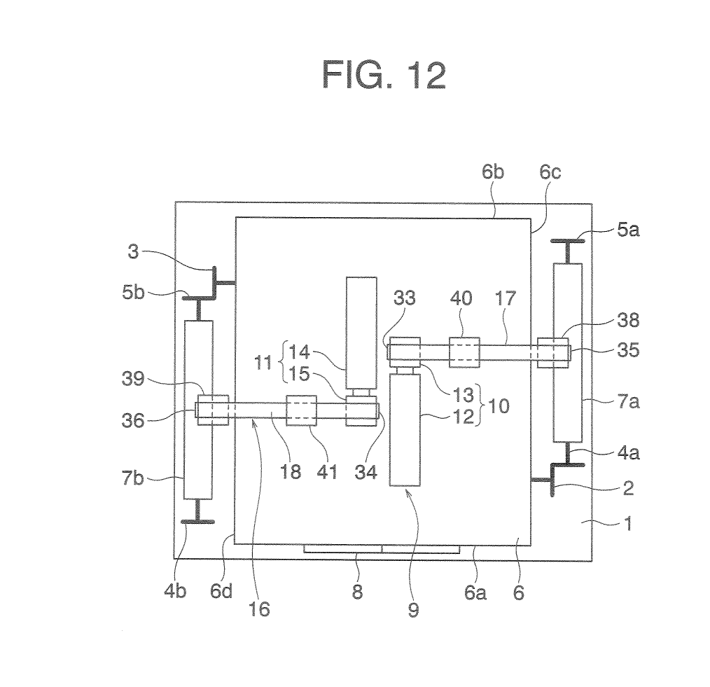

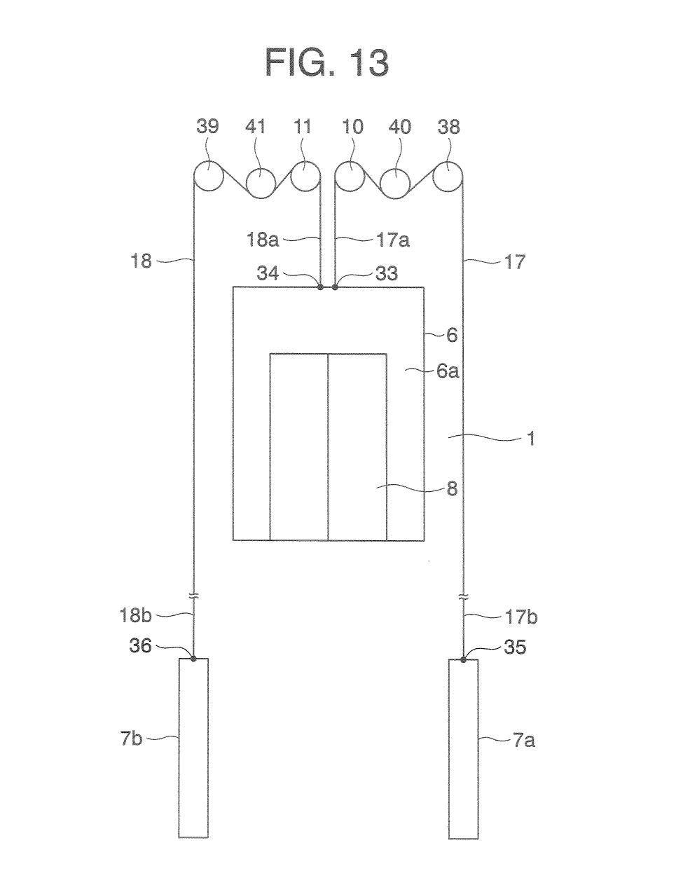

Reference will be made next to FIGS. 12 and 13. FIG. 12 is a schematic plan view showing an elevator apparatus according to Embodiment 8 of the present invention. FIG. 13 is a front view showing an essential part of the elevator apparatus of FIG. 12. Referring to FIGS. 12 and 13, the car guide rails 2 and 3 are disposed offset in opposite directions from a longitudinal center of the car 6. That is, the car guide rail 2 faces the first lateral surface portion 6c in front of the longitudinal center of the car 6. The car guide rail 3 faces the second lateral surface portion 6d behind the longitudinal center of the car 6.

The counterweight 7 is divided into a first counterweight 7a and a second counterweight 7b. The first counterweight 7a and the second counterweight 7b are equal in size and weight. The first counterweight 7a and the second counterweight 7b are disposed in a distributive manner on both sides of the car 6, respectively. That is, the first counterweight 7a is disposed so as to face the first lateral surface portion 6c when being located at the same height as the car 6, and the second counterweight 7b is disposed so as to face the second lateral surface portion 6d when being located the same height as the car 6.

In addition, the first counterweight 7a is disposed behind the first guide rail 2 in the longitudinal direction of the car 6, and the second counterweight 7b is disposed in front of the second car guide rail 3 in the longitudinal direction of the car 6.

The first counterweight suspending portion 35 to which the first suspension belt 17 is connected is provided on an upper portion of the first counterweight 7a. The second counterweight suspending portion 36 to which the second suspension belt 18 is connected is provided on an upper portion of the second counterweight 7b. The first deflector pulley 38 is disposed above the first counterweight 7a. The second deflector pulley 39 is disposed above the second counterweight 7b.

The car guide rails 2 and 3, the counterweights 7a and 7b, counterweight guide rails 4a, 5a, 4b, and 5b, the drive devices 10 and 11, the suspension belts 17 and 18, the deflector pulleys 38 and 39, and the looping angle adjusting pulleys 40 and 41 are disposed symmetrically around the center of gravity of the car 6 on the vertical projection plane, respectively. Embodiment 8 of the present invention is identical to Embodiment 7 of the present invention in other constructional details.

The elevator apparatus constructed as described above also makes it possible to increase the output of the drive means 9 without increasing the diameters of the motors, and hence realize large capacity and high speed with a compact installation space. It is also possible to reduce the diameters of the motors required for the achievement of the same performance as in the conventional art, and hence realize space saving.

Although the two drive devices 10 and 11 are illustrated in each of the foregoing examples, three or more drive devices may be employed.

Further, although the suspension belts 17 and 18 are illustrated as main rope bodies in each of the foregoing examples, suspension ropes with a circular cross-section may be employed.

Further, the roping arrangement should not be limited to the 1:1 roping arrangement or the 2:1 roping arrangement.

1. An elevator apparatus comprising:
a car and a counterweight that are raised and lowered within a hoistway;
suspension means having a shape of a belt, for suspending the and the counterweight within the hoistway; and
drive means disposed in an upper portion of the hoistway, for raising and lowering the car and the counterweight via the suspension means, wherein:
the drive means has a first drive device including a first drive sheave, and a second drive device including a second drive sheave;
each of the first drive device and the second drive device is larger in dimension in a direction along a corresponding one of rotary shafts of the first drive sheave and the second drive sheave than in a direction perpendicular to the corresponding one of the rotary shafts, and is disposed such that the corresponding one of the rotary shafts extends horizontally; and
the suspension means includes a first suspension belt wound around the first drive sheave, and a second suspension belt wound around toe second drive sheave.

2. An elevator apparatus comprising:
a car and a counterweight that are raised and lowered within a hoistway;
suspension means for suspending the car and the counterweight within the hoistway; and
drive means disposed in an upper portion of the hoistway, for raising and lowering the car and the counterweight via the suspension means, wherein:
the drive means has a first drive device including a first drive sheave, and a second drive device including a second drive sheave; and
each of the first drive device and the second drive device is larger in dimension in a direction along a corresponding one of rotary shafts of the first drive sheave and the second drive sheave than in a direction perpendicular to the corresponding one of the rotary shafts, and is disposed such that the corresponding one of the root shafts extends horizontally and so that each of the first drive device and the second drive device is located as a whole within a region between the car and a hoistway wall on a vertical projection plane.

3. The elevator apparatus according to claim 2, wherein the first drive device and the second drive device are disposed adjacent to each other in a direction that is horizontal and perpendicular to the rotary shafts.

4. The elevator apparatus according to claim 2, wherein the first drive device and the second drive device are disposed above the counterweight so as to be superposed on the counterweight on the vertical projection plane.

5. The elevator apparatus according claim 4, wherein the first drive device and the second drive device are disposed such that the rotary shafts extend parallel to a width direction of the counterweight, and are disposed adjacent to each other in a direction that is horizontal and parallel to the rotary shafts.

6. The elevator apparatus according to claim 5, wherein:
the first drive sheave and the second drive sheave are disposed at first axial ends of the first drive device and the second drive device, respectively; and
the first drive device and the second drive device are disposed such that second axial ends thereof face each other.

7. The elevator apparatus according to claim 5, wherein:
the first drive sheave and the second drive sheave are disposed at the first axial ends of the first drive device and the second drive device, respectively; and
the first drive device and the second drive device are disposed such that the first axial ends thereof face each other.

8. An elevator apparatus comprising:
a car and a counterweight that are raised and lowered within a hoistway;
suspension means for suspending the car and the counterweight within the hoistway; and
drive means disposed in an upper portion of the hoistway, for raising and lowering the car and the counterweight via the suspension means, wherein:
the drive means has a first drive device including a first drive sheave, and a second drive device including a second drive sheave; and
each of the first drive device and the second drive device is larger in dimension in a direction along a corresponding one of rotary shafts or the first drive sheave and the second drive sheave than in a direction perpendicular to the corresponding one of the rotary shafts, and is disposed such that the corresponding one of the rotary shafts extends horizontally and so that the first drive device and the second drive device are adjacent to each other in a direction that is horizontal and parallel to the rotary shafts.

9. An elevator apparatus comprising:
a car and a counterweight that are raised and lowered within a hoistway;
suspension means for suspending the car and the counterweight within the hoistway; and
drive means disposed in an upper portion of the hoistway, for raising and lowering the car and the counterweight via the suspension means, wherein:
the drive means has a first drive device including a first drive sheave, and a second drive device including a second drive sheave; and
each of the first drive device and the second drive device is larger in dimension in a direction along a corresponding one of rotary shafts of the first drive sheave and the second drive sheave than in a direction perpendicular to the corresponding one of the rotary shafts, and is disposed such that the corresponding one the rotary shafts extends horizontally and so that the first drive device and the second drive device vertically overlap with each other.

10. An elevator apparatus comprising:
a car and a counterweight that are raised and lowered within a hoistway;
suspension means for suspending the car and the counterweight within the hoistway; and
drive means disposed in an upper portion of the hoistway, for raising and lowering the car and the counterweight via the suspension means, wherein:
the car has a first car suspending portion and a second car suspending portion provided on an upper portion thereof;
the counterweight has a first counterweight suspending portion and a second counterweight suspending portion provided thereon;
the drive means has a first drive device including a first drive sheave, and a second drive device including a second drive sheave;
each of the first drive device and the second drive device is larger in dimension in a direction along a corresponding one of rotary shafts of the first drive sheave and the second drive sheave than in a direction perpendicular to the corresponding one of the rotary shafts, and is disposed such that the corresponding one or the rotary shafts extends horizontally and so that each of the first drive device and the second drive device is located within a region of the car on a vertical projection plane;
the suspension means includes a first suspension body wound around the first drive sheave and connected to the first car suspending portion and the first counterweight suspending portion, and a second suspension body wound around the second drive sheave and connected to the second car suspending portion and the second counterweight suspending portion; and
the counterweight has provided thereabove a deflector pulley device for leading the first suspension body and the second suspension body to the first counterweight suspending portion and the second counterweight suspending portion, respectively.

11. The elevator apparatus according to claim 10, wherein:
the counterweight has a first counterweight provided with the first counterweight suspending portion, and a second counterweight provided with the second counterweight suspending portion; and
the deflector pulley device has a first deflector pulley disposed above the first counterweight to lead the first suspension body to the first counterweight suspending portion, and a second deflector pulley disposed above the second counterweight to lead the second suspension body to the second counterweight suspending portion.

12. The elevator apparatus according to claim 11, wherein:
the car has a first lateral surface portion and a second lateral surface portion that face each other;
the hoistway has installed therein a first car guide rail for guiding the car during raising and lowering thereof and a second car guide rail for guiding the car during raising and lowering thereof;
first car guide rail faces the first lateral surface portion in front of a longitudinal center of the car;
the second car guide rail faces the second lateral surface portion behind the longitudinal center of the car;
the counterweight is disposed behind the first car guide rail in a longitudinal direction of the car; and
the second counterweight is disposed in front of the second car guide rail in the longitudinal direction of the car.
